(19) United States
(12) Patent Application Publication
(10) Pub. No.: US 2026/0346545 A1
(43) Pub. Date: Nov. 5, 2026

(54) THERMAL CARBONATED POLYMERS

(71) Applicant: Southern University and A&M College, Baton Rouge, LA (US)

(72) Inventor: Fareed Dawan, Baton Rouge, LA (US)

(73) Assignee: Southern University and A&M College, Baton Rouge, LA (US)

(21) Appl. No.: 19/740,509

(22) Filed: Jul. 14, 2026

Related U.S. Application Data
(63) Continuation-in-part of application No. 18/208,825, filed on Jun. 12, 2023.

(51) Int. Cl. B29C 64/314; B33Y 40/10; B33Y 70/00

(52) U.S. Cl. CPC B29C 64/314; B33Y 40/10; B33Y 70/00; B29K 2995/0046

(57) ABSTRACT

A carbonated polymer comprising a cured polymer matrix formed by curing a polymer precursor after intentional introduction of carbon dioxide into the polymer precursor is disclosed. The carbonated polymer exhibits thermal characteristics differing from corresponding cured polymers produced from the polymer precursor without intentional introduction of carbon dioxide, including increased thermal stability, reduced thermal transition behavior, lower thermal-profile slopes determined by differential scanning calorimetry, and reduced specific heat capacity. The carbonated polymer is suitable for fabrication of three-dimensional articles and may be produced using radiation-curable polymer systems and additive manufacturing processes, including vat photopolymerization.

### CROSS-REFERENCE TO RELATED APPLICATIONS

This application is a Continuation-in-Part of and claims the benefit of and priority to U.S. Non-Provisional Patent Application No. 18/208,825, entitled "3D Printable Carbonated Polymer," filed on Jun. 12, 2023, the entire disclosure of which is incorporated herein by reference to the fullest extent permitted by law.

### FIELD OF THE INVENTION

The present disclosure relates generally to additive manufacturing and polymer science. More particularly, the present disclosure relates to methods of intentionally introducing carbon dioxide into a polymer precursor prior to curing to produce a carbonated polymer suitable for additive manufacturing. The disclosure further relates to carbonated polymers produced according to such methods and to representative embodiments of such carbonated polymers exhibiting advantageous material characteristics.

### BACKGROUND OF THE INVENTION

Additive manufacturing technologies, including stereolithography (SLA), Digital Light Processing (DLP), liquid crystal display (LCD) printing, and related vat-photopolymerization techniques, have enabled production of complex three-dimensional polymeric articles with high dimensional accuracy and relatively low material waste. Such technologies commonly utilize liquid photosensitive polymer resins that are selectively cured by electromagnetic radiation to form solid polymeric articles.

Numerous efforts have been directed toward modifying polymeric materials used in additive manufacturing to improve one or more material properties. Such efforts have included the addition of solid fillers, reinforcing fibers, nanoparticles, ceramic particles, metallic particles, and other additives intended to influence structural, thermal, electrical, optical, or other characteristics of the resulting polymeric article.

Carbon dioxide has been used in various industrial processes involving polymers, including polymer foaming, polymer processing, polymer expansion, and supercritical-fluid applications. Such processes generally utilize carbon dioxide for purposes other than intentionally producing a carbonated polymer suitable for additive manufacturing.

Despite continuing advances in polymer processing and additive manufacturing, a need remains for improved methods of producing polymeric materials suitable for additive manufacturing while providing additional material characteristics that may benefit the resulting printed articles.

### SUMMARY OF THE INVENTION

The present disclosure provides methods of intentionally introducing carbon dioxide into a polymer precursor prior to curing to produce a carbonated polymer suitable for additive manufacturing. In representative embodiments, carbon dioxide is intentionally incorporated into a photosensitive polymer precursor before polymerization such that curing of the polymer precursor produces a carbonated polymer.

In certain embodiments, the carbonated polymer is produced by exposing a polymer precursor to carbon dioxide under conditions sufficient to incorporate carbon dioxide into the polymer precursor before curing. The carbonated polymer may subsequently be formed into one or more three-dimensional articles using additive manufacturing processes including, without limitation, stereolithography (SLA), Digital Light Processing (DLP), liquid crystal display (LCD) printing, and other vat-photopolymerization techniques.

Representative embodiments of carbonated polymers produced according to the disclosed methods were characterized to evaluate material properties resulting from the intentional incorporation of carbon dioxide into the polymer precursor. As described herein, representative characterization demonstrated that carbonated polymers produced according to the disclosed methods exhibited material characteristics differing from corresponding polymeric materials manufactured without intentional incorporation of carbon dioxide.

In representative embodiments, characterization demonstrated unexpected thermal characteristics associated with carbonated polymers produced according to the disclosed methods. Representative thermal characterization included evaluation of thermal response, heat-flow behavior, specific heat capacity, thermal-transition behavior, and related thermal characteristics.

Representative embodiments likewise demonstrated unexpected structural and mechanical characteristics associated with carbonated polymers produced according to the disclosed methods. Representative mechanical characterization included evaluation of elastic modulus and related structural characteristics. The representative characterization described herein demonstrates that intentional incorporation of carbon dioxide into a polymer precursor may produce carbonated polymers exhibiting material behavior that differs from conventional expectations regarding incorporation of carbon dioxide into polymeric materials.

The disclosed methods, carbonated polymers, additive-manufacturing processes, and representative characterizations collectively provide a foundation for producing carbonated polymeric materials exhibiting advantageous material characteristics while preserving the manufacturing advantages associated with additive manufacturing technologies.

Additional features, advantages, and aspects of the disclosed invention will become apparent from the following Detailed Description, the accompanying drawings, and the appended claims.

### BRIEF DESCRIPTION OF THE DRAWINGS

The accompanying drawings illustrate representative embodiments of the disclosed invention and, together with the following Detailed Description, serve to explain the principles of the disclosed methods and carbonated polymers. The drawings are intended to illustrate representative embodiments and should not be interpreted as limiting the scope of the invention.

FIG. 1 illustrates one exemplary embodiment of a carbonation system configured to intentionally introduce carbon dioxide into a polymer precursor prior to curing.

FIG. 2 illustrates one exemplary embodiment of a method of producing a carbonated resin through intentional incorporation of carbon dioxide into the polymer precursor.

FIG. 3 illustrates one exemplary embodiment of a carbonated resin produced according to the disclosed carbonation method.

FIG. 4 illustrates one exemplary embodiment of a carbonated polymer article produced by curing the carbonated resin.

FIG. 5 illustrates representative carbonated polymer specimens produced according to the disclosed methods.

FIG. 6 illustrates representative processing and post-curing of carbonated polymer specimens.

FIG. 7 illustrates one exemplary embodiment of an additive-manufacturing system suitable for producing three-dimensional carbonated polymer articles.

FIG. 8 illustrates a representative layer-by-layer fabrication process for producing a carbonated polymer article.

FIG. 9 illustrates representative characterization of carbonated polymer specimens.

FIG. 10 illustrates representative thermal characterization of carbonated polymer specimens.

FIG. 11 illustrates representative thermodynamic characterization of carbonated polymer specimens.

FIG. 12 illustrates representative mechanical characterization of carbonated polymer specimens.

FIG. 13 illustrates representative characterization of a carbonated polymer microstructure according to one embodiment of the present disclosure.

### DETAILED DESCRIPTION OF THE INVENTION

Reference will now be made in detail to representative embodiments of the present disclosure. Wherever possible, like reference numerals designate like or corresponding elements throughout the drawings. The following Detailed Description is provided to enable one of ordinary skill in the art to make and use the disclosed invention and is presented in the context of representative embodiments. Various modifications, equivalents, substitutions, and alternative implementations will become apparent to those skilled in the art in view of the present disclosure. Accordingly, the disclosed embodiments are not intended to limit the scope of the invention as defined by the appended claims.

Unless otherwise expressly indicated, directional terms such as "upper," "lower," "top," "bottom," "left," "right," "longitudinal," "lateral," "vertical," and "horizontal" are used for convenience with reference to the illustrated embodiments and are not intended to require any particular orientation during manufacture or use.

Likewise, references to one embodiment, representative embodiments, certain embodiments, or exemplary embodiments are intended to describe illustrative implementations of the disclosed invention and should not be interpreted as requiring that every embodiment include every described feature or advantage.

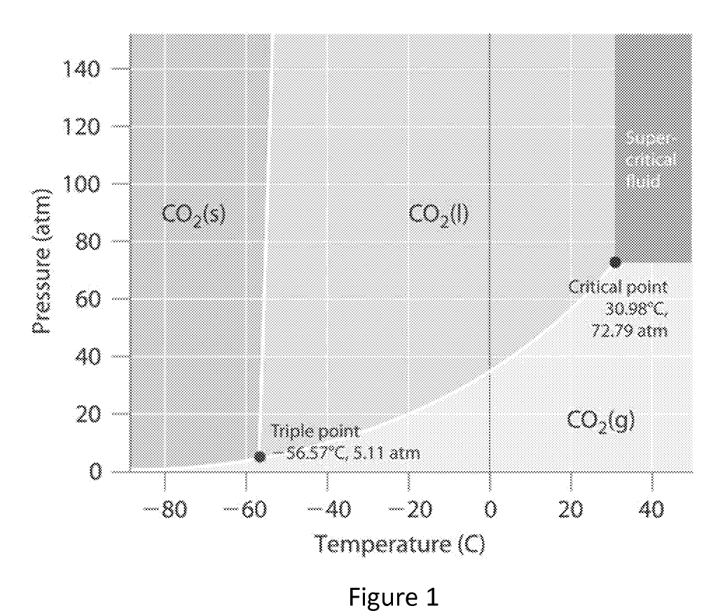

Referring now to FIG. 1, carbonation system 100 is illustrated according to one representative embodiment of the present disclosure. Carbonation system 100 is configured to intentionally introduce carbon dioxide into a polymer precursor before curing to produce a carbonated resin that may subsequently be cured to form a carbonated polymer.

In the illustrated embodiment, carbonation system 100 comprises pressure vessel 102 configured to receive polymer precursor 104. Pressure vessel 102 is fluidly coupled to a carbon dioxide source 106 through conduit 108. Valve assembly 110 selectively controls the introduction of carbon dioxide into pressure vessel 102, thereby permitting carbon dioxide to be intentionally introduced into polymer precursor 104 under selected processing conditions.

Polymer precursor 104 may comprise a photosensitive resin suitable for additive manufacturing. Representative polymer precursors include radiation-curable polymer formulations capable of undergoing curing following intentional incorporation of carbon dioxide. In representative embodiments, the polymer precursor comprises a resin suitable for stereolithography, Digital Light Processing, liquid crystal display printing, or other vat-photopolymerization processes.

Carbon dioxide source 106 may comprise any suitable source of carbon dioxide capable of supplying carbon dioxide to pressure vessel 102 under controlled conditions. Valve assembly 110 may comprise one or more manually operated valves, automated valves, regulators, pressure-control devices, flow-control devices, or combinations thereof.

During operation, carbon dioxide is intentionally introduced into polymer precursor 104 within pressure vessel 102 under conditions selected to produce a carbonated resin. Representative processing conditions may include selected pressures, exposure durations, temperatures, agitation conditions, or combinations thereof. The particular processing conditions may vary depending upon the selected polymer precursor and the desired characteristics of the resulting carbonated polymer.

Following intentional incorporation of carbon dioxide into polymer precursor 104, the resulting carbonated resin may be transferred to an additive-manufacturing system for curing and production of one or more carbonated polymer articles.

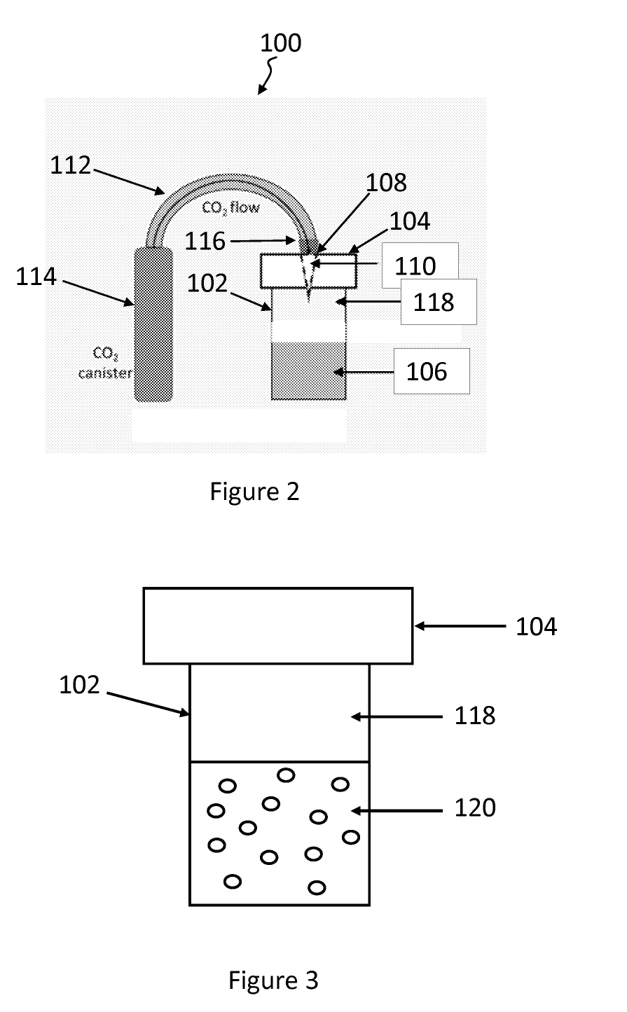

Referring now to FIG. 2, one representative method 200 of producing a carbonated resin is illustrated. Method 200 begins by providing polymer precursor 104 within pressure vessel 102.

Carbon dioxide is intentionally introduced into polymer precursor 104 under selected processing conditions to produce carbonated resin 120. In representative embodiments, carbon dioxide is introduced before curing of the polymer precursor such that subsequent curing produces a carbonated polymer.

Following intentional incorporation of carbon dioxide, carbonated resin 120 may be subjected to one or more processing operations including mixing, agitation, transfer, degassing (where appropriate), storage, or combinations thereof prior to curing. The particular processing sequence may vary depending upon the selected manufacturing process.

Carbonated resin 120 is subsequently cured to produce a carbonated polymer suitable for additive manufacturing. In representative embodiments, curing is performed by exposing selected portions of carbonated resin 120 to electromagnetic radiation in a layer-by-layer additive-manufacturing process.

Although representative embodiments are described with reference to additive manufacturing, carbonated resins produced according to the disclosed methods may likewise be utilized in other polymer-forming processes compatible with the disclosed materials and curing techniques.

Referring now to FIG. 3, carbonated resin 120 is illustrated according to one representative embodiment of the present disclosure. Carbonated resin 120 is produced by intentionally introducing carbon dioxide into polymer precursor 104 using carbonation system 100 described above. Carbonated resin 120 is configured for subsequent curing to produce a carbonated polymer suitable for additive manufacturing.

In representative embodiments, carbon dioxide is intentionally incorporated into polymer precursor 104 prior to curing under selected processing conditions sufficient to produce carbonated resin 120. The amount of carbon dioxide introduced into polymer precursor 104 may vary depending upon the selected polymer precursor, the selected manufacturing process, and the desired characteristics of the resulting carbonated polymer.

Carbonated resin 120 may comprise one or more photosensitive polymer formulations suitable for additive manufacturing. Representative formulations include polymer systems compatible with stereolithography (SLA), Digital Light Processing (DLP), liquid crystal display (LCD) printing, and other radiation-curable additive-manufacturing processes.

Following intentional incorporation of carbon dioxide into polymer precursor 104, carbonated resin 120 may be transferred directly to an additive-manufacturing system for curing or may undergo one or more intermediate processing operations before curing, depending upon the selected manufacturing process.

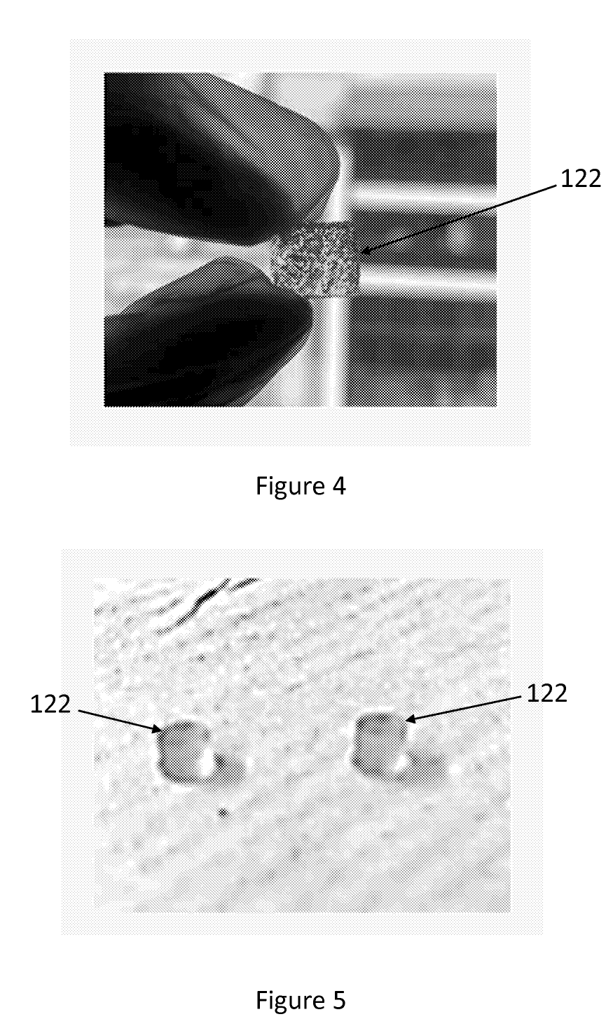

Referring now to FIG. 4, carbonated polymer article 122 is illustrated according to one representative embodiment of the present disclosure. Carbonated polymer article 122 is produced by curing carbonated resin 120 after intentional incorporation of carbon dioxide into polymer precursor 104.

Carbonated polymer article 122 may comprise a representative specimen, test article, prototype component, production component, or other three-dimensional article manufactured according to the disclosed methods. The illustrated geometry is representative only and should not be interpreted as limiting the scope of the disclosed invention.

In representative embodiments, carbonated polymer article 122 is produced by selectively curing successive portions of carbonated resin 120 using an additive-manufacturing process. Following curing, the resulting article comprises a carbonated polymer produced according to the disclosed methods.

Although the representative embodiment illustrates a generally rectangular article suitable for characterization, carbonated polymers produced according to the disclosed methods may be formed into articles having substantially any geometry compatible with the selected manufacturing process.

Referring now to FIG. 5, representative carbonated polymer specimens 124 are illustrated. Representative specimens 124 are produced according to the disclosed methods and are suitable for evaluation of one or more material characteristics.

Representative specimens 124 may be produced using substantially identical manufacturing conditions to facilitate comparison of material characteristics among different representative embodiments. The dimensions, geometry, and configuration of representative specimens 124 may be selected according to the intended characterization protocol or manufacturing application.

Although representative specimens 124 are illustrated for purposes of explanation, the disclosed methods are applicable to substantially any article capable of being manufactured from carbonated resin 120 according to the teachings of the present disclosure.

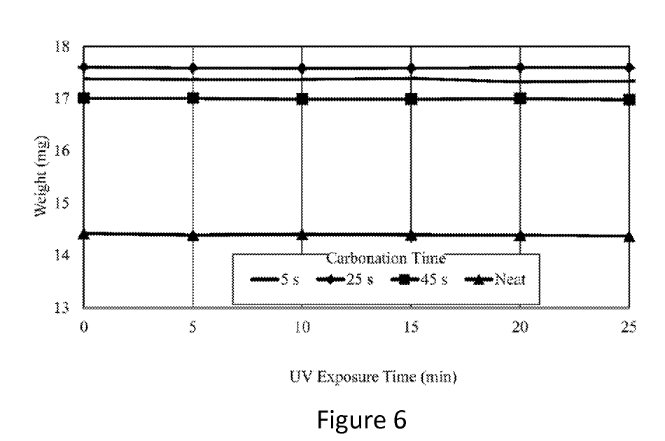

Referring now to FIG. 6, representative processing of carbonated polymer specimens is illustrated. Following production of carbonated resin 120, representative embodiments may undergo one or more curing and post-curing operations to produce the finished carbonated polymer.

Representative post-curing operations may include exposure to ultraviolet radiation, visible radiation, thermal energy, controlled environmental conditions, or combinations thereof. The selected post-curing process may vary according to the polymer precursor employed and the intended application of the resulting carbonated polymer.

One advantage of the disclosed methods is that intentional incorporation of carbon dioxide into the polymer precursor is compatible with conventional post-curing techniques used for additive manufacturing. Accordingly, representative embodiments may be manufactured using existing additive-manufacturing workflows while producing carbonated polymers according to the present disclosure.

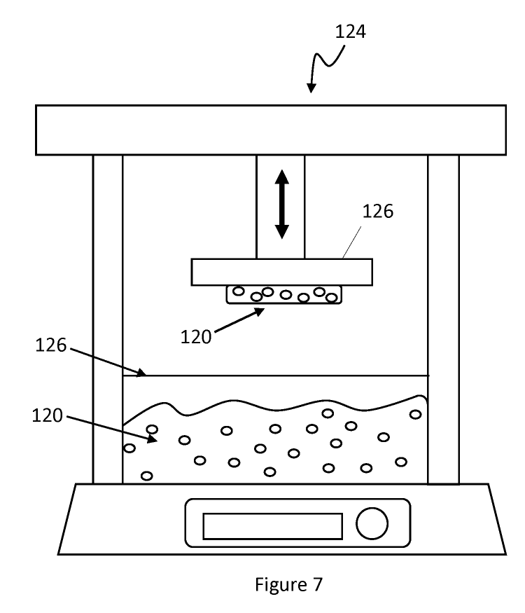

Referring now to FIG. 7, representative additive-manufacturing system 126 is illustrated. Additive-manufacturing system 126 is configured to cure carbonated resin 120 to produce one or more carbonated polymer articles.

In the illustrated embodiment, additive-manufacturing system 126 comprises vat 128 configured to receive carbonated resin 120, build platform 130, and radiation source 132 configured to selectively cure portions of carbonated resin 120 during manufacture of the carbonated polymer article.

Successive curing operations produce corresponding successive layers of the carbonated polymer until completion of the desired three-dimensional article. The disclosed methods are compatible with layer-by-layer additive-manufacturing processes employing photosensitive polymer formulations.

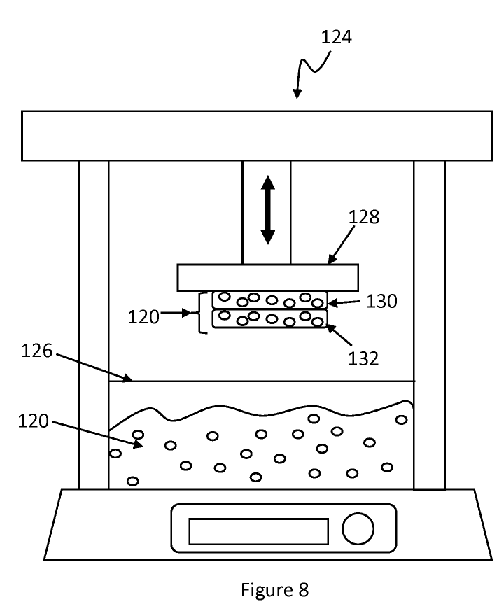

Referring now to FIG. 8, representative layer-by-layer fabrication of a carbonated polymer article is illustrated. Carbonated resin 120, produced through intentional incorporation of carbon dioxide into polymer precursor 104, is selectively cured to produce successive layers forming the finished carbonated polymer article.

The thickness of each layer, exposure conditions, curing sequence, post-curing operations, and related manufacturing parameters may be selected according to the particular additive-manufacturing process employed and the intended application of the finished article.

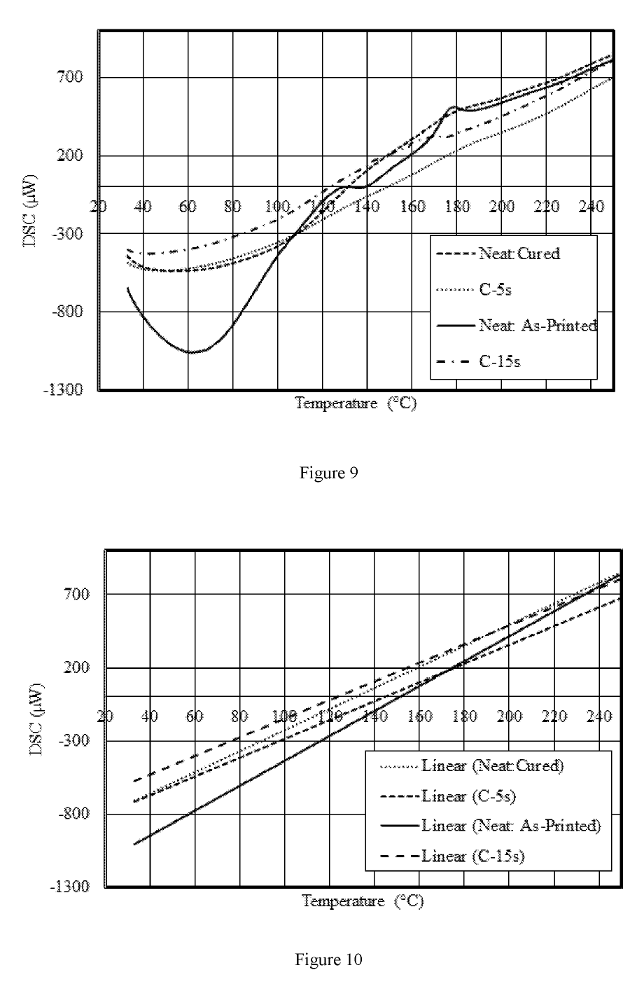

Representative carbonated polymer articles produced according to the disclosed methods are suitable for subsequent characterization to evaluate one or more thermal, thermodynamic, structural, or mechanical characteristics. Representative characterization of such articles is described below with reference to FIGS. 9-13.

Representative embodiments of carbonated polymers produced according to the methods disclosed herein were subjected to thermal and mechanical characterization to evaluate material characteristics associated with the intentional incorporation of carbon dioxide into the polymer precursor. Unless otherwise indicated, the representative characterization compares carbonated polymers produced according to the disclosed methods with corresponding polymeric materials manufactured without intentional incorporation of carbon dioxide. The characterization described herein is representative of embodiments produced according to the present disclosure and is provided to further illustrate the disclosed invention.

The representative characterization demonstrates that intentional incorporation of carbon dioxide into the polymer precursor produces carbonated polymers exhibiting material characteristics differing from corresponding polymeric materials manufactured without intentional incorporation of carbon dioxide. As discussed below, representative embodiments exhibited unexpected thermal characteristics and unexpected structural and mechanical characteristics associated with the disclosed carbonated polymers.

Referring now to FIG. 9, representative differential scanning calorimetry (DSC) thermal profiles of carbonated polymer specimens produced according to the disclosed methods are illustrated. The thermal profiles correspond to representative as-printed specimens, neat cured specimens, and carbonated specimens produced by intentionally incorporating carbon dioxide into the polymer precursor before curing.

Differential scanning calorimetry was employed to evaluate the thermal behavior of representative carbonated polymers. The representative as-printed specimens exhibited more pronounced endothermic and exothermic transitions associated with thermal curing over a temperature range of approximately 35°C to 125°C.

Representative neat cured specimens exhibited improved thermal stability relative to the as-printed specimens by exhibiting less pronounced thermal transition behavior. Representative carbonated polymer specimens exhibited still greater thermal stability than the corresponding neat cured specimens.

The representative thermal characterization therefore demonstrates that carbonated polymers produced by intentionally introducing carbon dioxide into the polymer precursor exhibit thermal behavior differing from corresponding polymeric materials manufactured without intentional incorporation of carbon dioxide.

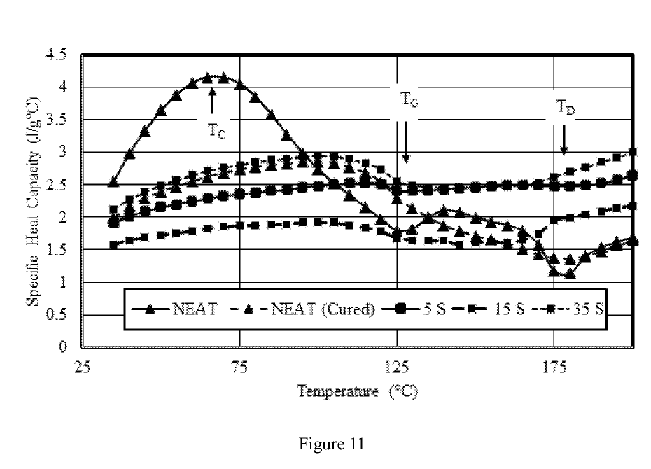

Referring now to FIG. 10, linearized thermal profiles corresponding to the representative differential scanning calorimetry characterization are illustrated. Linear regression approximations of the thermal curing profiles provide a comparative representation of thermal stability among the evaluated specimens.

The representative carbonated polymer specimens exhibited lower thermal-profile slopes than corresponding neat cured and as-printed specimens. The lower slopes observed for the representative carbonated polymers indicate increased thermal stability over a broad temperature range, whereas the comparatively higher slopes associated with the neat cured and as-printed specimens indicate comparatively reduced thermal stability.

The representative characterization therefore demonstrates that intentional incorporation of carbon dioxide into the polymer precursor produces carbonated polymers exhibiting thermal characteristics differing from corresponding polymeric materials manufactured without intentional incorporation of carbon dioxide.

Referring now to FIG. 11, representative specific heat capacity measurements of carbonated polymer specimens are illustrated. The representative characterization evaluates the influence of intentional incorporation of carbon dioxide into the polymer precursor on the thermal properties of the resulting carbonated polymer.

Representative characterization demonstrated that the specific heat capacity of the representative carbonated polymer was reduced by approximately 40% relative to the corresponding neat polymer.

The observed reduction in specific heat capacity demonstrates that the intentionally incorporated carbon dioxide contributes to the thermal behavior of the resulting carbonated polymer in a manner consistent with a composite material. Representative characterization therefore demonstrates that intentional incorporation of carbon dioxide into the polymer precursor produces thermal characteristics that differ from those exhibited by corresponding polymeric materials manufactured without intentional incorporation of carbon dioxide.

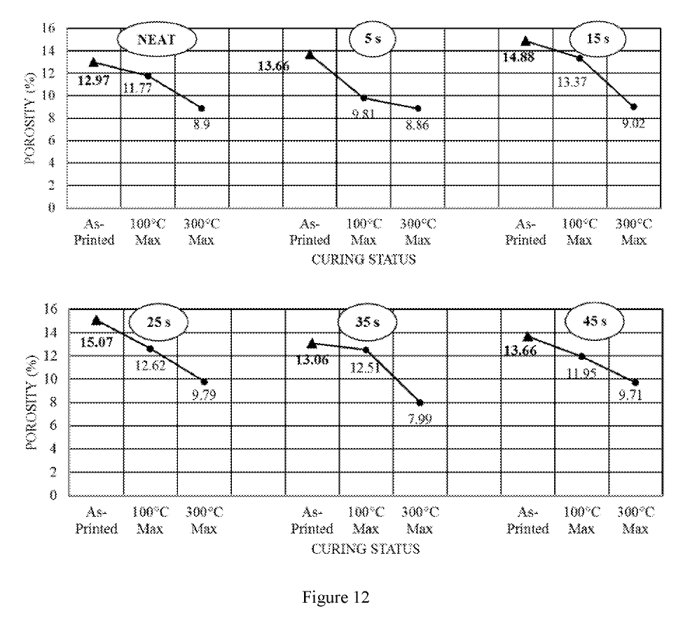

Referring now to FIG. 12, representative porosity characterization of carbonated polymer specimens is illustrated. Porosity measurements were obtained using a helium pycnometer to evaluate representative embodiments produced according to the disclosed methods.

For representative as-printed specimens carbonated over progressively increasing carbonation durations from 0 seconds to 45 seconds, measured porosity increased from approximately 12.97% to a maximum of approximately 15.07%. Representative characterization further demonstrated that the measured porosity increase is attributable to interfacial regions between the polymer matrix and the carbon dioxide microbubbles rather than to the carbon dioxide microbubbles themselves.

Accordingly, the representative characterization demonstrates that the intentionally incorporated carbon dioxide microbubbles behave as filler constituents within the carbonated polymer rather than as voids. Representative embodiments therefore exhibit material characteristics associated with composite polymer materials rather than polymer foams.

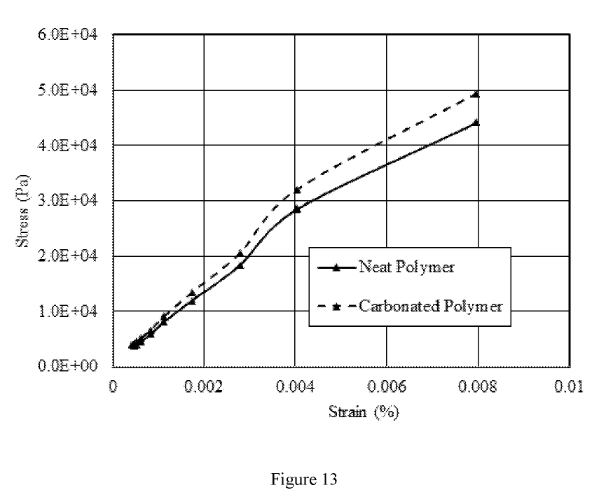

Referring now to FIG. 13, representative dynamic mechanical analysis (DMA) of carbonated polymer specimens is illustrated. Compressive mechanical testing was performed on representative neat polymer specimens and representative carbonated polymer specimens produced according to the disclosed methods. The representative carbonated specimens correspond to specimens carbonated for approximately 15 seconds, representing the thermally optimum carbonation condition identified during the thermal characterization.

The representative characterization demonstrated that the carbonated polymer exhibited an approximately 70% increase in the average elastic modulus (E') relative to the corresponding neat polymer specimen. The observed increase in elastic modulus demonstrates that intentional incorporation of carbon dioxide into the polymer precursor produces carbonated polymers exhibiting structural and mechanical characteristics differing from corresponding polymeric materials manufactured without intentional incorporation of carbon dioxide. The representative characterization further demonstrates that the carbon dioxide microbubbles behave as filler constituents within the carbonated polymer, thereby contributing to the observed increase in mechanical performance.

Collectively, the representative characterization described with reference to FIGS. 9–13 demonstrates that carbonated polymers produced by intentionally introducing carbon dioxide into a polymer precursor according to the disclosed methods exhibit material characteristics differing from corresponding polymeric materials manufactured without intentional incorporation of carbon dioxide. Representative embodiments demonstrated unexpected improvements in thermal behavior, including increased thermal stability over a broad temperature range and a reduction in specific heat capacity of approximately 40%, while representative embodiments likewise demonstrated unexpected structural and mechanical behavior, including evidence that the intentionally incorporated carbon dioxide microbubbles behave as filler constituents rather than voids and an approximately 70% increase in average elastic modulus (E') relative to corresponding neat polymer specimens. Collectively, these representative characterizations further demonstrate that intentional incorporation of carbon dioxide into a polymer precursor produces carbonated polymers exhibiting advantageous thermal and structural characteristics that would not have been expected based upon conventional understanding of carbon dioxide incorporation into polymeric materials.

The illustrated embodiment depicts representative incorporation of carbon dioxide within the carbonated polymer produced by intentional introduction of carbon dioxide into the polymer precursor before curing. The illustration is schematic in nature and is not intended to depict actual dimensions, spatial relationships, concentrations, or distributions.

The representative microstructure is provided to assist in understanding the disclosed carbonated polymer and should not be interpreted as requiring any particular microscopic morphology unless expressly recited in the claims.

Representative characterization of carbonated polymers produced according to the disclosed methods demonstrates that intentional incorporation of carbon dioxide into a polymer precursor may impart multiple classes of advantageous material characteristics. Representative embodiments described herein exhibited thermal characteristics differing from corresponding polymeric materials manufactured without intentional incorporation of carbon dioxide. Representative embodiments likewise exhibited structural and mechanical characteristics differing from corresponding polymeric materials manufactured without intentional incorporation of carbon dioxide, including increased elastic modulus in representative embodiments. Collectively, the representative characterization further demonstrates that intentional incorporation of carbon dioxide into a polymer precursor produces carbonated polymers exhibiting material behavior that would not have been expected based upon conventional understanding of carbon dioxide incorporation into polymeric materials.

Although exemplary embodiments have been described with reference to particular polymer precursors, additive-manufacturing systems, and representative processing conditions, the disclosed methods are not limited to the specific embodiments illustrated herein. One of ordinary skill in the art will recognize that numerous modifications may be made without departing from the scope of the disclosed invention.

Representative embodiments may employ a variety of polymer precursors suitable for additive manufacturing. Such polymer precursors may include photosensitive resins, radiation-curable resins, photopolymerizable compositions, acrylate-based systems, methacrylate-based systems, epoxy-based systems, hybrid polymer systems, water-soluble polymer systems, isomalt-containing formulations, and other polymer formulations compatible with intentional incorporation of carbon dioxide before curing.

Carbon dioxide may be intentionally introduced into the selected polymer precursor using pressures, exposure durations, temperatures, mixing conditions, or other processing parameters selected according to the particular polymer precursor and the intended manufacturing process. The disclosed methods are not limited to any particular carbonation pressure, exposure duration, or processing sequence unless expressly recited in the claims.

Although representative embodiments have been described with reference to vat-photopolymerization processes, carbonated resins produced according to the disclosed methods may be utilized in other manufacturing processes compatible with the selected polymer precursor and curing mechanism. Accordingly, the disclosed methods should not be interpreted as being limited solely to any particular additive-manufacturing technology.

The foregoing description of representative embodiments has been presented for purposes of illustration and description. It is not intended to be exhaustive or to limit the invention to the precise embodiments disclosed. Numerous modifications, variations, substitutions, additions, omissions, and equivalent arrangements will be apparent to persons of ordinary skill in the art in view of the present disclosure.

What is claimed is:

1. A carbonated polymer comprising:
a cured polymer matrix produced by curing a polymer precursor after intentional introduction of carbon dioxide into the polymer precursor,
wherein differential scanning calorimetry of the carbonated polymer demonstrates endothermic and exothermic thermal transition behavior over a temperature range of approximately 35° C. to approximately 125° C.,
wherein the carbonated polymer exhibits greater thermal stability than a corresponding cured polymer produced from the polymer precursor without intentional introduction of carbon dioxide,
wherein the carbonated polymer exhibits a reduction in specific heat capacity of approximately 40% relative to the corresponding cured polymer produced from the polymer precursor without intentional introduction of carbon dioxide,
wherein linearized differential scanning calorimetry demonstrates a lower thermal-profile slope than the corresponding cured polymer produced from the polymer precursor without intentional introduction of carbon dioxide,
and wherein the lower thermal-profile slope is indicative of increased thermal stability resulting from intentional introduction of carbon dioxide into the polymer precursor.

2. The carbonated polymer of claim 1, wherein the polymer precursor comprises a radiation-curable polymer precursor suitable for additive manufacturing.

3. The carbonated polymer of claim 2, wherein the radiation-curable polymer precursor comprises a photosensitive resin.

4. The carbonated polymer of claim 1, wherein the carbon dioxide is intentionally introduced into the polymer precursor while the polymer precursor is in an uncured state.

5. The carbonated polymer of claim 1, wherein the carbonated polymer is produced by curing a carbonated resin formed by intentionally introducing carbon dioxide into the polymer precursor.

6. The carbonated polymer of claim 5, wherein the carbonated resin is cured by exposure to electromagnetic radiation.

7. The carbonated polymer of claim 6, wherein the electromagnetic radiation comprises ultraviolet radiation.

8. The carbonated polymer of claim 1, wherein the carbonated polymer is produced by a vat-photopolymerization additive manufacturing process.

9. The carbonated polymer of claim 8, wherein the vat-photopolymerization additive manufacturing process comprises a Digital Light Processing (DLP) process, a stereolithography (SLA) process, or a liquid crystal display (LCD) printing process.

10. The carbonated polymer of claim 1, wherein the greater thermal stability is evidenced by less pronounced endothermic and exothermic thermal transition behavior than exhibited by the corresponding cured polymer produced from the polymer precursor without intentional introduction of carbon dioxide.

11. A carbonated polymer comprising a cured polymer matrix produced by curing a polymer precursor after intentional introduction of carbon dioxide into the polymer precursor, wherein the intentional introduction of carbon dioxide produces a carbonated polymer having greater thermal stability than a corresponding cured polymer produced from the polymer precursor without intentional introduction of carbon dioxide.

12. The carbonated polymer of claim 11, wherein the differing thermal characteristics comprise reduced thermal transition behavior relative to the corresponding cured polymer.

13. The carbonated polymer of claim 11, wherein the differing thermal characteristics comprise a lower thermal-profile slope than the corresponding cured polymer.

14. The carbonated polymer of claim 13, wherein the lower thermal-profile slope is determined using linearized differential scanning calorimetry.

15. The carbonated polymer of claim 11, wherein the differing thermal characteristics comprise reduced specific heat capacity relative to the corresponding cured polymer.

16. The carbonated polymer of claim 11, wherein the carbonated polymer is produced by curing a carbonated resin formed by intentionally introducing carbon dioxide into the polymer precursor before curing.

17. The carbonated polymer of claim 11, wherein the carbonated polymer is configured for fabrication of a three-dimensional article using an additive manufacturing process selected from the group consisting of stereolithography (SLA), Digital Light Processing (DLP), liquid crystal display (LCD) printing, and combinations thereof.

18. A carbonated polymer comprising:
a cured polymer matrix formed by curing a polymer precursor after intentional introduction of carbon dioxide into the polymer precursor,
wherein the intentional introduction of carbon dioxide into the polymer precursor produces a carbonated polymer having thermal properties that differ from corresponding cured polymers produced from the polymer precursor without intentional introduction of carbon dioxide.

19. The carbonated polymer of claim 18, wherein the differing thermal properties comprise greater thermal stability than the corresponding cured polymer produced from the polymer precursor without intentional introduction of carbon dioxide.

20. The carbonated polymer of claim 18, wherein the differing thermal properties are demonstrated by one or more of:
(a) differential scanning calorimetry;
(b) linearized differential scanning calorimetry;
(c) thermal transition behavior; or
(d) specific heat capacity characterization.
